(19) United States
(12) Patent Application Publication
(10) Pub. No.: US 2026/0046787 A1
(43) Pub. Date: Feb. 12, 2026

(54) ENABLEMENT OF USER EQUIPMENT TO REPORT USED POWER CLASS

(71) Applicant: Nokia Technologies Oy, Espoo (FI)

(72) Inventors: Hiromasa UMEDA, Tokyo (JP); Hideaki TAKAHASHI, Tokyo (JP); Juha Pekka KARJALAINEN, Oulu (FI)

(21) Appl. No.: 18/998,734

(22) PCT Filed: Jun. 28, 2023
(86) PCT No.: PCT/IB2023/056711

§ 371 Date: Jan. 27, 2025

Related U.S. Application Data
(60) Provisional application No. 63/395,510, filed on Aug. 5, 2022.

(51) Int. Cl. H04W 52/36; H04W 52/14

(52) U.S. Cl. CPC H04W 52/365; H04W 52/146

(57) ABSTRACT

Systems, methods, apparatuses, and computer program products enabling user equipment (UE) to report used power class (PC). A method may include transmitting a message including user equipment capability information to a network element. The method may also include receiving from the network element in response to the message, configuration for reporting power class information, or a start timing of an uplink duty cycle evaluation and a length of the uplink duty cycle evaluation. The method may further include transmitting a report including the power class information or the start timing and the length of the uplink duty cycle evaluation to the network element in response to the configuration.

### RELATED APPLICATION

This application claims priority to U.S. Provisional Application No. 63/395,510 filed Aug. 5, 2022, which is incorporated herein by reference in its entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for enabling user equipment (UE) to report used power class (PC).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include transmitting a message including user equipment capability information to a network element. The method may also include receiving from the network element in response to the message, configuration for reporting power class information, or a start timing of an uplink duty cycle evaluation and a length of the uplink duty cycle evaluation. The method may further include transmitting a report including the power class information or the start timing and the length of the uplink duty cycle evaluation to the network element in response to the configuration.

Other example embodiments may be directed to an apparatus. The apparatus may include at least one processor and at least one memory including computer program code. The at least one memory and computer program code may also be configured to, with the at least one processor, cause the apparatus at least to transmit a message including user equipment capability information to a network element. The apparatus may also be caused to receive from the network element in response to the message, configuration for reporting power class information, or a start timing of an uplink duty cycle evaluation and a length of the uplink duty cycle evaluation. The apparatus may further be caused to transmit a report including the power class information or the start timing and the length of the uplink duty cycle evaluation to the network element in response to the configuration.

Other example embodiments may be directed to an apparatus. The apparatus may include means for transmitting a message including user equipment capability information to a network element. The apparatus may also include means for receiving from the network element in response to the message, configuration for reporting power class information, or a start timing of an uplink duty cycle evaluation and a length of the uplink duty cycle evaluation. The apparatus may further include means for transmitting a report including the power class information or the start timing and the length of the uplink duty cycle evaluation to the network element in response to the configuration.

In accordance with other example embodiments, a non-transitory computer readable medium may be encoded with instructions that may, when executed in hardware, perform a method. The method may include transmitting a message including user equipment capability information to a network element. The method may also include receiving from the network element in response to the message, configuration for reporting power class information, or a start timing of an uplink duty cycle evaluation and a length of the uplink duty cycle evaluation. The method may further include transmitting a report including the power class information or the start timing and the length of the uplink duty cycle evaluation to the network element in response to the configuration.

Other example embodiments may be directed to a computer program product that performs a method. The method may include transmitting a message including user equipment capability information to a network element. The method may also include receiving from the network element in response to the message, configuration for reporting power class information, or a start timing of an uplink duty cycle evaluation and a length of the uplink duty cycle evaluation. The method may further include transmitting a report including the power class information or the start timing and the length of the uplink duty cycle evaluation to the network element in response to the configuration.

Other example embodiments may be directed to an apparatus that may include circuitry configured to measure, at the apparatus, a radio altimeter signal. The apparatus may also include circuitry configured to transmit a message including user equipment capability information to a network element. The apparatus may also include circuitry configured to receive from the network element in response to the message, configuration for reporting power class information, or a start timing of an uplink duty cycle evaluation and a length of the uplink duty cycle evaluation. The apparatus may further include circuitry configured to transmit transmitting a report including the power class information or the start timing and the length of the uplink duty cycle evaluation to the network element in response to the configuration.

Certain example embodiments may be directed to a method. The method may include receiving, from a user equipment, a message including user equipment capability information. The method may also include transmitting to the user equipment in response to the message, a configuration for reporting power class information, or a start timing of an uplink duty cycle evaluation and a length of the uplink duty cycle evaluation. The method further includes receiving, from the user equipment, a report including the power class information or the start timing and the length of the uplink duty cycle evaluation. In addition, the method includes scheduling, based on the report, a resource for the user equipment.

Other example embodiments may be directed to an apparatus. The apparatus may include at least one processor and at least one memory including computer program code. The at least one memory and computer program code may be configured to, with the at least one processor, cause the apparatus at least to receive, from a user equipment, a message including user equipment capability information. The apparatus may also be caused to transmit to the user equipment in response to the message, a configuration for reporting power class information, or a start timing of an uplink duty cycle evaluation and a length of the uplink duty cycle evaluation. The apparatus may further be caused to receive, from the user equipment, a report including the power class information or the start timing and the length of the uplink duty cycle evaluation. In addition, the apparatus may be caused to schedule, based on the report, a resource for the user equipment.

Other example embodiments may be directed to an apparatus. The apparatus may include means for receiving, from a user equipment, a message including user equipment capability information. The apparatus may also include means for transmitting to the user equipment in response to the message, a configuration for reporting power class information, or a start timing of an uplink duty cycle evaluation and a length of the uplink duty cycle evaluation. The apparatus may further include means for receiving, from the user equipment, a report including the power class information or the start timing and the length of the uplink duty cycle evaluation. In addition, the apparatus may include means for scheduling, based on the report, a resource for the user equipment.

In accordance with other example embodiments, a non-transitory computer readable medium may be encoded with instructions that may, when executed in hardware, perform a method. The method may include receiving, from a user equipment, a message including user equipment capability information. The method may also include transmitting to the user equipment in response to the message, a configuration for reporting power class information, or a start timing of an uplink duty cycle evaluation and a length of the uplink duty cycle evaluation. The method further includes receiving, from the user equipment, a report including the power class information or the start timing and the length of the uplink duty cycle evaluation. In addition, the method includes scheduling, based on the report, a resource for the user equipment.

Other example embodiments may be directed to a computer program product that performs a method. The method may include receiving, from a user equipment, a message including user equipment capability information. The method may also include transmitting to the user equipment in response to the message, a configuration for reporting power class information, or a start timing of an uplink duty cycle evaluation and a length of the uplink duty cycle evaluation. The method further includes receiving, from the user equipment, a report including the power class information or the start timing and the length of the uplink duty cycle evaluation. In addition, the method includes scheduling, based on the report, a resource for the user equipment.

Other example embodiments may be directed to an apparatus that may include circuitry configured to receive, from a user equipment, a message including user equipment capability information. The apparatus may also include circuitry configured to transmit to the user equipment in response to the message, a configuration for reporting power class information, or a start timing of an uplink duty cycle evaluation and a length of the uplink duty cycle evaluation. The apparatus may further include circuitry configured to receive, from the user equipment, a report including the power class information or the start timing and the length of the uplink duty cycle evaluation. In addition, the apparatus may include circuitry configured to schedule, based on the report, a resource for the user equipment.

### BRIEF DESCRIPTION OF THE DRAWINGS

For proper understanding of example embodiments, reference should be made to the accompanying drawings, wherein:

FIG. 1 illustrates an example relationship between power class transition and full power modes.

FIG. 2 illustrates an example signal flow diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for enabling user equipment (UE) to report power class (PC) that is to be used, or a currently used PC.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of 3rd Generation Partnership Project (3GPP) introduces several higher power classes (PC) than default PC in an effort to improve uplink (UL) coverage and capacity. For instance, Table 1 shows a list of example defined PCs in Frequency Range 1 (FR1).

TABLE 1
Defined PCs in FR1

| Power | |
|---|---|
| Class | Nominal output power |
| 1 | 31 dBm(For CPE |
| | devices) |
| 1.5 | 29 dBm |
| 2 | 26 dBm |
| 3 | 23 dBm |

Due to regulatory requirements such as specific absorption rate (SAR), a UE supporting a higher PC than a default PC is allowed to fallback to lower PC(s) down to default power class in FR1. Additionally, many UE features may be tied to PC, and UE behavior may be defined in terms of fallback of the UE to lower PC(s). However, there has not been any consideration as to when the UE should exactly fallback, and when the UE should return from a lower PC to a higher PC. Additionally, without knowing the PC status, the network may not have any knowledge on how to appropriately handle these features.

Many of UE capabilities and UE performances according to the capabilities may be associated with UE PC per band or per band combination (BC). For example, one PC per band or per BC may be reported by a UE while the UE is allowed to fallback to lower PC(s) in some cases and return to the declared PC or a PC between a default PC and the declared (i.e., highest) PC at a certain point. However, there is currently no precise definition of when the UE falls back to a lower PC or a default PC, or when the UE returns to the declared PC. In some instances, there may be some conditions that allow the UE to fallback such as, for example, an UL duty cycle threshold or P-max. However, an evaluation period of the UL duty cycle is not clearly specified. Thus, the network cannot know what the exact PC being used at a certain moment is. This may cause certain problems including, for example, the network configuring the UE with a certain feature associated with a PC while the UE may not be in the expected PC at that moment. Thus, the UE cannot follow the instruction provided by the network. Another problem is that the network cannot schedule resources such as resource blocks (RBs), modulation and coding schemes (MCS), etc., according to the currently being used PC even though some UE radio frequency (RF) performance requirements are different according to the PC.

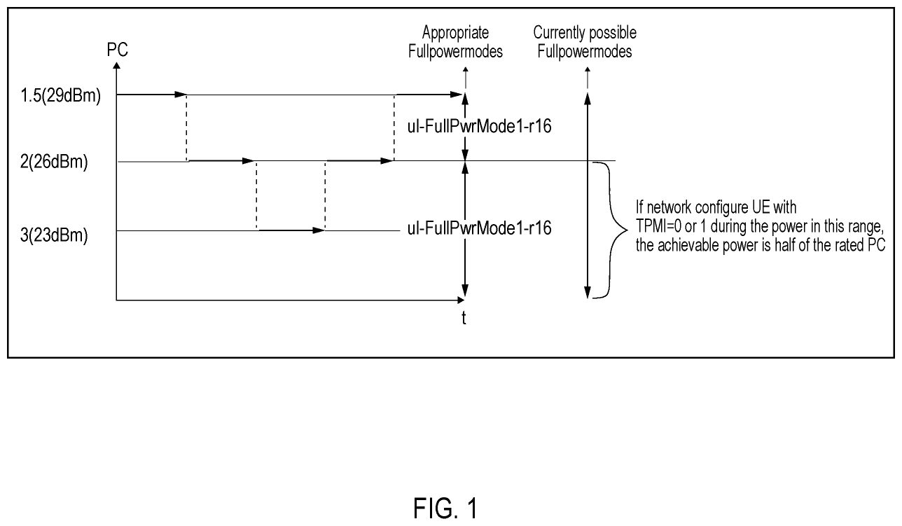

FIG. 1 illustrates an example relationship between PC transition (fallback/return) and full power modes. As illustrated in FIG. 1, another problem may be associated with the relationship between PC and associated ul-FullPowerTransmission. The ul-FullPowerTransmission parameter may include various transmission modes that can be used to overcome issues in UL codebook-based transmissions, the non-coherent and partial-coherent codebook subsets. This may also be applicable to lower rank transmissions that cannot reach the maximum output power (declared by the UE) with a power scaling mechanism. Assuming a UE supporting a band with PC1.5 (29 decibel-milliwatts (dBm)) for a band (e.g., n41), the UE may be able to support ul-FullPwrModel-r16 where the UE can achieve full power with TPMI=2, i.e., 1/V √2[1 1] T, since PC1.5 for n41 performance requirements were developed with the assumption that 26 dBm capable PA x 2 implementation. On the other hand, the UE using n41 may be allowed to fallback to PC2 (26 dBm) for some cases, e.g., as described in TS 38.101-1, if the field of UE capability maxUplinkDutyCycle-PC2-FR1 and the field of UE capability maxUplinkDutyCycle-MPE-FR1 are absent, and the percentage of UL symbols transmitted in a certain evaluation period is larger than 25%, the exact evaluation period is no less than one radio frame. Additionally, it is allowed to fallback to even PC3 (23 dBm) if the percentage is larger than 50% in the above case.

If PC1.5 falls back to PC2, then the supported ul-FullPwr mode(s) may become different (i.e., ul-FullPwrMode-r16) while the network cannot know which PC is currently being used. Thus, the network cannot know if the UE can determine which ul-FullPwr mode(s) is applied, and the network may wrongly configure the UE with ul-FullPwrModel-r16 even when the UE is the PC2 state for n41. In this case, if one of the ports channel conditions is not good, the network may configure the UE with TPMI=0 (1/√2 [1 0]^{T}) or 1 (1/√2 [0 1]^{T}). Then, the achievable power is half of the rated power class (i.e., 23 dBm even if the UE is in PC2 status and 20 dBm if the UE is in PC3 status, respectively).

Other issues associated with UE PC per band or per BC may arise in relation between PC and associated sounding reference signal (SRS) antenna switching. For instance, assuming that a UE supports a band with PC1.5 (29 dBm) for a band (e.g., n41), if the UE is in the PC1.5 state, the network may desire to use 2T4R for antenna switching to shorten the time for channel evaluation. On the other hand, the UE may be in PC2 (26 dBm) state. In this case, if the network keeps configuring the UE with 2T4R, the power per antenna may become less than or equal to 23 dBm because the total power from the two antenna ports is capped by 26 dBm. If the network knew that the UE is in PC2, it may want to configure the UE with 1T4R to increase the power per antenna up to 26 dBm at the cost of more occasions for switching. Additionally, issues associated with UE PC per band or per BC may arise in relation between PC fallback and UL resource allocation. In this case, if the UE is in PC2 state due to the fallback, the UE may keep using PC2 as far as the percentage is smaller or equal to 50%. Moreover, performance requirements such as additional maximum power reduction (A-MPR), MPR, maximum sensitivity degradation (MSD) may become different. If the network was able to know that the UE is in PC2 state, the network would be able to refrain from allocating UL duty cycle more than 50%. This would enable the network to avoid the situation that the UE further fallbacks to PC3, and would schedule/configure the UE with appropriate resources and/or features according to PC2 performance requirement such as MPR/A-MPR as one of the factors. Additionally, a network may speculate the UE's PC state from UL duty cycle, but it would not be able to know it precisely since the exact evaluation period is not defined to leave some UE implementation flexibility.

Another issue associated with UE PC per band or per BC may arise in relation between PC fallback and reference sensitivity. Here, it may be proposed to allow the UE supporting a frequency division duplex (FDD) PC2 band to autonomously fallback to PC3 when reference sensitivity is degraded due to self-interference (mainly noise due to non-linearity from its own Tx power toward its own Rx band) inside the same UE while the sensitivity degradation due to “the self-interference” cannot be known by the network. Thus, the network would not be able to know if the UE is in the PC2 or the PC3 state if the UE autonomously falls back to PC3 or returns to PC2.

A further issue associated with UE PC band per BC may arise in relation between PC fallback and Tx diversity. In this case, the UE may indicate, as capability, that if PC2 UE with Tx diversity fallbacks to PC3, then one Tx is used. However, there are no measures for the network to know which PC the UE is using at that moment in time. Thus, the capability alone may not be useful. Additionally, it is noted that power headroom (PHR) with P_{CMAX.f.c} does not give a clear PC. Specifically, P_{CMAX.f.c} is the value taken by the UE between P_{CMAX.f.c} L and P_{CMAX.f.c} H, and the range can overlap even the UE is in a different PC state at a moment.

One way to resolve the above problems may be to enable the UE to report the being used PC state (i.e., currently used PC state) for a band or BC at an instance to network whenever the being used PC has changed. However, allowing the UE to autonomously report the PC information means that network would need to reserve certain UL resources for the UE to report it, and valuable UL resources would be used in an inefficient manner since the PC state change may not frequently occur under a certain condition.

Another possible way to resolve the above problems may be for the UE to share, with the network, conditions to determine when the UL duty cycle period evaluation starts and its period length. In this case, the UE may fallback to the defined default PC if the UL duty cycle exceeds a predefined threshold that it reports to the network as UE capability. However, the exact evaluation period and its start timing of the evaluation (or trigger event condition) have not been specified. If the power is low enough (though the level may depend on UE implementation), the UE may not have to fallback to the default power class since the UE can meet regulatory requirements such as SAR without any problems. In this case, the UE may not conduct the evaluation at all. Thus, it may be challenging to define one single evaluation period and/or its start timing for UE to report as a UE capability.

In view of the above problems, certain example embodiments may establish a signaling mechanism that allows the network to instruct the UE to report the PC that is currently being used, and/or an UL duty cycle evaluation start timing and its length for a band or BC at a given moment. This reporting may also include a frequency of the reporting as well as its window that the network designates. For instance, in certain example embodiments, a signaling mechanism may be established that allows the network to instruct the UE to report the currently used PC and/or UL duty cycle evaluation start timing and its length for a band or BC at a given moment. The report may also include a frequency of the reporting, as well as a window of the reporting that the network designates. For instance, the window may correspond to a time window where the UE is allowed to report the PC that is being used.

In other example embodiments, the UE may report a UE capability to the network. The UE may also report the PC that the UE is currently using, and/or an UL duty cycle evaluation period and a length of the UL duty cycle evaluation period for fallback or return depending on PC status if requested by the network.

According to some example embodiments, the UE may report a threshold in terms of PHR to trigger UL duty cycle evaluation as a UE capability to the network.

In certain example embodiments, once the network receives the report from the UE, the network may calculate the UL duty cycle and monitor whether the UL duty cycle exceeds the reported threshold, or if it approaches the threshold. In some example embodiments, the threshold may be reported to the network from the UE as one of the UE capabilities in a maxUplinkDutyCycle-PC2-FR1 parameter. According to certain example embodiments, when the network determines that the UL duty cycle exceeds the threshold, the network may further consider how much power is left by utilizing the PHR information, at which point the network may not start and monitor the UL duty cycle. Alternatively, if the power does not remain that much (i.e., the amount of available power is small) and if PHR almost stays, the network may start and monitor the UL duty cycle. Thus, in certain example embodiments, from the UL duty cycle calculation and monitoring and/or PHR information, the network may be able to estimate the timing of when the UE changes its PC. The network may then reduce the number of requests to the UE to report the PC.

In other example embodiments, once the network receives the report from the UE, the network may calculate and monitor the UL duty cycle in a conservative way (e.g., depending on the PHR information), if the power does not remain that much (i.e., the amount of available power is small). For instance, the UL duty cycle may be calculated and monitored by sliding an evaluation window. According to certain example embodiments, calculating and monitoring the UL duty cycle in a conservative way may include calculating the UL duty cycle in the least evaluation period (e.g., one radio symbol) and/or taking a threshold in terms of PHR in a relaxed way (i.e., the amount of available power may not be small). Additionally, with regard to sliding the evaluation window, it may be assumed that a window of one radio frame with index of m where each of the radio frames contains n symbols. Duty cycle may be calculated per one radio frame after sliding one symbol.

According to certain example embodiments, the network may enable the UE to report the PC that the UE is currently using, or report an UL duty cycle evaluation start timing and its length as assistance information. According to some example embodiments, the UL duty cycle evaluation start timing and its length may be needed since at the timing of the UE reporting, the PC may not be still the previous PC, but is going to change or may change, where the UE is evaluating the necessity of fallback or return. With the information, the network may more accurately expect when fallback/return would happen if the threshold is satisfied, and ask the UE for its PC in an aperiodic way if necessary.

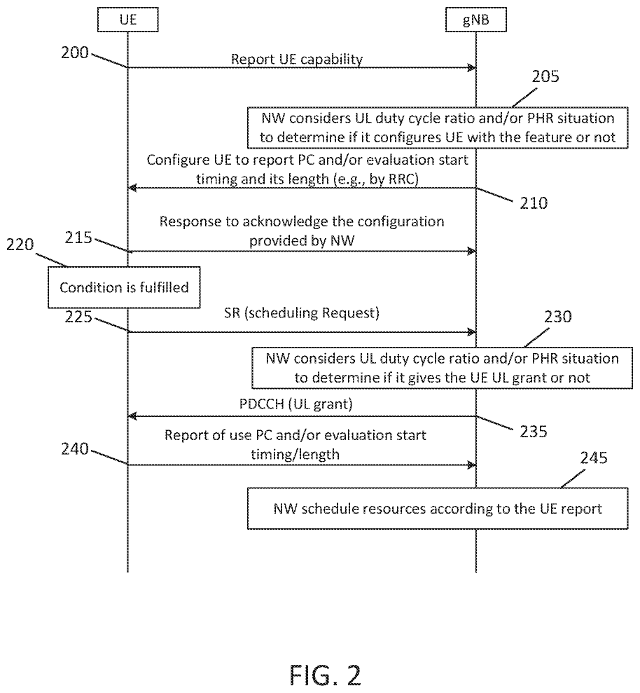

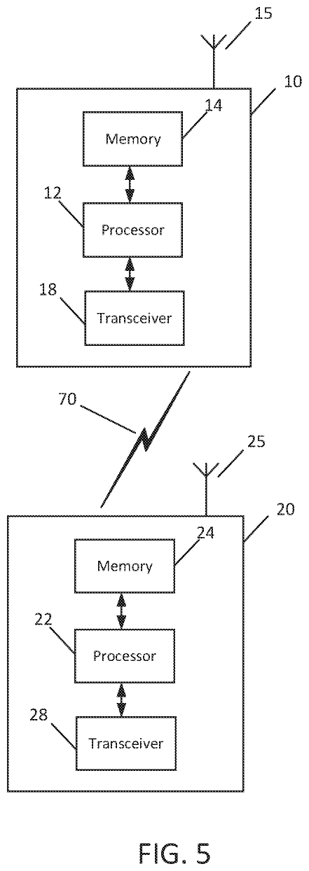

FIG. 2 illustrates an example signal flow diagram, according to certain example embodiments. In certain example embodiments, the functions illustrated in FIG. 2 may be performed by a device similar to one of apparatuses 10 or 20 illustrated in FIG. 5. At 200, the UE may transmit a report to the gNB that may include UE capability information which indicates that the UE supports the reporting of its PC and/or the evaluation period/start timing/evaluation triggering threshold. At 205, the gNB may consider UL duty cycle ratio and/or a PHR situation to determine whether it should configure the UE with a certain feature. In certain example embodiments, the PHR may be independently reported from the declared PC as UE capability, and the PC may be reported by the feature that the UE is configured with. At 210, the gNB may configure the UE to report the currently used PC by the UE and/or an UL duty cycle evaluation start timing and its length. According to certain example embodiments, the UE may report this information according to the configuration by the gNB via a radio resource control (RRC).

As further illustrated in FIG. 2, at 215, the UE may transmit a response to the gNB acknowledging the configuration provided by the gNB. At 220, the UE may determine that the condition has been fulfilled. That is, in certain example embodiments, if the evaluation does not start, there may be no need for the UE to report anything. Only the UE can know the conditions, and the network may inquire the UE if the evaluation has started, or if the PC has already changed, and the UE may then report such information to the network. At 225, the UE may also transmit a scheduling request (SR) to the gNB for UL grants that the UE may use for data transmission. At 230, the gNB may consider, based on the received scheduling request, the UL duty cycle ratio and/or PHR situation to determine whether the gNB should give the UE an UL grant. At 235, the gNB may transmit an UL grant via physical downlink control channel (PDCCH) to the UE. At 240, in response to the UL grant, the UE may transmit a report of the PC currently used by the UE and/or an UL duty cycle evaluation start timing and its length to the gNB. In certain example embodiments, the declared PC may be reported as UE capability. At 245, the gNB may schedule resources for the UE according to the received report.

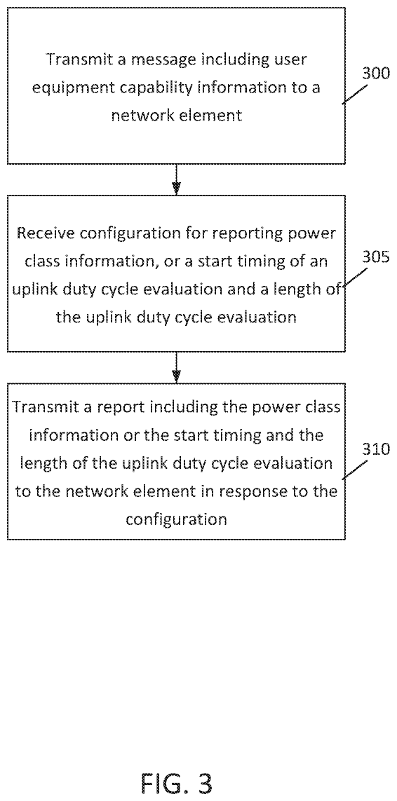

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE similar to one of apparatuses 10 or 20 illustrated in FIG. 5.

According to certain example embodiments, the method of FIG. 3 may include, at 300, transmitting a message including user equipment capability information to a network element. The method may also include, at 305, receiving from the network element in response to the message, configuration for reporting power class information, or a start timing of an uplink duty cycle evaluation and a length of the uplink duty cycle evaluation. The method may further include, at 310, transmitting a report including the power class information or the start timing and the length of the uplink duty cycle evaluation to the network element in response to the configuration.

According to certain example embodiments, the method may also include transmitting to the network element an evaluation threshold in terms of a power headroom value to trigger the uplink duty cycle evaluation. According to some example embodiments, the method may further include receiving, in response to the power class information or the start timing and the length of the uplink duty cycle evaluation, a configuration for a user equipment feature. According to other example embodiments, the method may also include receiving, in response to the power class information or the start timing and the length of the uplink duty cycle evaluation, a resource grant allocation for data transmission.

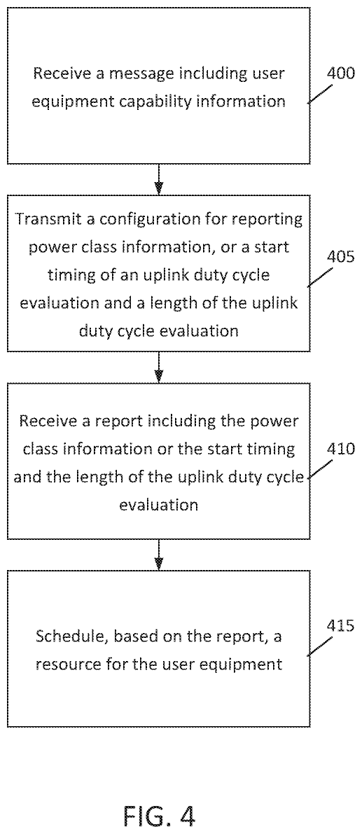

FIG. 4 illustrates an example of a flow diagram of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a gNB, network, cell, or any other device similar to one of apparatuses 10 or 20 illustrated in FIG. 5.

According to certain example embodiments, the method of FIG. 4 may include, at 400, receiving, from a user equipment, a message including user equipment capability information. The method may also include, at 405, transmitting to the user equipment in response to the message, a configuration for reporting power class information, or a start timing of an uplink duty cycle evaluation and a length of the uplink duty cycle evaluation. The method may further include, at 410, receiving, from the user equipment, a report including the power class information or the start timing and the length of the uplink duty cycle evaluation. In addition, the method may include, at 415, scheduling, based on the report, a resource for the user equipment.

According to certain example embodiments, the method may also include receiving, from the user equipment, an evaluation threshold in terms of a power headroom value to trigger the uplink duty cycle evaluation. According to some example embodiments, the resource may include configuration for a user equipment feature, or a resource grant allocation for data transmission. In certain example embodiments, the UL grant may include MCS and the number of RBs for data transmission. In further example embodiments, the resource grant allocation may correspond to allocation of the resource grant (i.e., DL resource allocation of transmitting PDCCH to the UE). That is, it may correspond to a grant of (radio) resource allocation for data transmission. According to other example embodiments, the method may further include determining whether the uplink duty cycle evaluation exceeds a predefined threshold. In certain example embodiments, based on the determination, the method may further include starting or stopping uplink duty cycle monitoring. In other example embodiments, based on the determination, the method may also include determining an uplink duty cycle in a least evaluation period or by taking a threshold in terms of a power headroom value in a relaxed way.

FIG. 5 illustrates a set of apparatus 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 10 may include components or features not shown in FIG. 5.

As illustrated in the example of FIG. 5, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-4.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-4.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IOT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to transmit a message including user equipment capability information to a network element. Apparatus 10 may also be controlled by memory 14 and processor 12 to receive from the network element in response to the message, configuration for reporting power class information, or a start timing of an uplink duty cycle evaluation and a length of the uplink duty cycle evaluation. Apparatus 10 may further be controlled by memory 14 and processor 12 to transmit a report including the power class information or the start timing and the length of the uplink duty cycle evaluation to the network element in response to the configuration.

As illustrated in the example of FIG. 5, apparatus 20 may be a network, core network element, or element in a communications network or associated with such a network, such as a gNB. It should be noted that one of ordinary skill in the art would understand that apparatus 20 may include components or features not shown in FIG. 5.

As illustrated in the example of FIG. 5, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein. In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to receive, from a user equipment, a message including user equipment capability information. Apparatus 20 may also be controlled by memory 24 and processor 22 to transmit to the user equipment in response to the message, a configuration for reporting power class information, or a start timing of an uplink duty cycle evaluation and a length of the uplink duty cycle evaluation. Apparatus 20 may further be controlled by memory 24 and processor 22 to receive, from the user equipment, a report including the power class information or the start timing and the length of the uplink duty cycle evaluation. In addition, apparatus 20 may be controlled by memory 24 and processor 22 to schedule, based on the report, a resource for the user equipment.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for transmitting a message including user equipment capability information to a network element. The apparatus may also include means for receiving from the network element in response to the message, configuration for reporting power class information, or a start timing of an uplink duty cycle evaluation and a length of the uplink duty cycle evaluation. The apparatus may further include means for transmitting a report including the power class information or the start timing and the length of the uplink duty cycle evaluation to the network element in response to the configuration.

Certain example embodiments may also be directed to an apparatus that includes means for receiving, from a user equipment, a message including user equipment capability information. The apparatus may also include means for transmitting to the user equipment in response to the message, a configuration for reporting power class information, or a start timing of an uplink duty cycle evaluation and a length of the uplink duty cycle evaluation. The apparatus may further include means for receiving, from the user equipment, a report including the power class information or the start timing and the length of the uplink duty cycle evaluation. In addition, the apparatus may include means for scheduling, based on the report, a resource for the user equipment.

Certain example embodiments described herein provide several technical improvements, enhancements, and/or advantages. For instance, in some example embodiments, it may be possible to establish a signaling mechanism that allows the network to instruct the UE to report the being used PC and/or UL duty cycle evaluation start timing and its length for a band or BC at a given moment. In certain example embodiments, the report may also include a frequency of the reporting as well as its window that the network designates. In other example embodiments, the network may be provided with a precise PC status of the UE, and may also be provided with such information in a more efficient manner.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| A-MPR | Additional Maximum Power Reduction |
| BC | Band Combination |
| BS | Base Station |
| CPE | Customer Premises Equipment |
| DL | Downlink |
| eNB | Enhanced Node B |
| E-UTRAN | Evolved UTRAN |
| FDD | Frequency Division Duplex |
| FR | Frequency Range |
| gNB | 5G or Next Generation NodeB |
| HPUE | High Power UE |
| LTE | Long Term Evolution |
| MCS | Modulation and Coding Scheme |
| MPR | Maximum Power Reduction |
| MSD | Maximum Sensitivity Degradation |
| NR | New Radio |
| NW | Network |
| PC | Power Class |
| PHR | Power Headroom |
| RRC | Radio Resource Control |
| Rx | Receive |
| SAR | Specific Absorption Rate |
| TDD | Time Division Duplex |
| Tx | Transmit |
| UE | User Equipment |
| UL | Uplink |

1-36. (canceled)

37. An apparatus, comprising:
at least one processor; and
at least one memory including computer program code; the at least one memory and the computer program code configured to, with storing instructions that, when executed by the at least one processor, cause the apparatus at least to:
transmit a message comprising user equipment capability information to a network element;
receive, from the network element in response to the message, configuration for reporting power class information, or a start timing of an uplink duty cycle evaluation and a length of the uplink duty cycle evaluation; and
transmit a report comprising the power class information or the start timing and the length of the uplink duty cycle evaluation to the network element based on the configuration.

38. The apparatus according to claim 37, wherein the at least one memory and the computer program code are further configured to, with storing instructions that, when executed by the at least one processor, cause the apparatus at least to:
transmit to the network element an evaluation threshold in terms of a power headroom value to trigger the uplink duty cycle evaluation.

39. The apparatus according to claim 37, wherein the at least one memory and the computer program code are further configured to, with storing instructions that, when executed by the at least one processor, cause the apparatus at least to:
receive, in response to the power class information or the start timing and the length of the uplink duty cycle evaluation, a configuration for a user equipment feature.

40. The apparatus according to claim 37, wherein the at least one memory and the computer program code are further configured to, with storing instructions that, when executed by the at least one processor, cause the apparatus at least to:
receive, in response to the power class information or the start timing and the length of the uplink duty cycle evaluation, a resource grant allocation for data transmission.

41. The apparatus according to claim 37, wherein the at least one memory and the computer program code are further configured to, with storing instructions that, when executed by the at least one processor, cause the apparatus at least to:
transmit to the network element a response to acknowledge the received configuration.

42. The apparatus according to claim 37, wherein the at least one memory and the computer program code are further configured to, with storing instructions that, when executed by the at least one processor, cause the apparatus at least to:
determine at least one condition is fulfilled;
wherein the report is transmitted when the at least one condition is fulfilled.

43. The apparatus according to claim 42, wherein the at least one memory and the computer program code are further configured to, with storing instructions that, when executed by the at least one processor, cause the apparatus at least to:
transmit, to the network element, a scheduling request when the at least one condition is fulfilled;
receive an uplink grant from the network element;
wherein the report is transmitted in response to receiving the uplink grant.

44. A method comprising:
transmitting a message comprising user equipment capability information to a network element;
receiving from the network element in response to the message, configuration for reporting power class information, or a start timing of an uplink duty cycle evaluation and a length of the uplink duty cycle evaluation; and
transmitting a report comprising the power class information or the start timing and the length of the uplink duty cycle evaluation to the network element based on the configuration.

45. The method according to claim 44, further comprising:
transmitting to the network element an evaluation threshold in terms of a power headroom value to trigger the uplink duty cycle evaluation.

46. The method according to claim 44, further comprising:
receiving, in response to the power class information or the start timing and the length of the uplink duty cycle evaluation, a configuration for a user equipment feature.

47. The method according to claim 44, further comprising:
receiving, in response to the power class information or the start timing and the length of the uplink duty cycle evaluation, a resource grant allocation for data transmission.

48. The method according to claim 44, further comprising:
transmitting to the network element a response to acknowledge the received configuration.

49. The method according to claim 44, further comprising:
determining at least one condition is fulfilled;
wherein the report is transmitted when the at least one condition is fulfilled.

50. The method according to claim 49, further comprising:
transmitting, to the network element, a scheduling request when the at least one condition is fulfilled;
receiving an uplink grant from the network element;
wherein the report is transmitted in response to receiving the uplink grant.

51. An apparatus, comprising:
at least one processor; and
at least one memory including computer program code,
the at least one memory and the computer program code configured to, with storing instructions that, when executed by the at least one processor, cause the apparatus at least to:
receive, from a user equipment, a message comprising user equipment capability information;
transmit, to the user equipment in response to the message, a configuration for reporting power class information, or a start timing of an uplink duty cycle evaluation and a length of the uplink duty cycle evaluation;
receive, from the user equipment, a report comprising the power class information or the start timing and the length of the uplink duty cycle evaluation; and
schedule, based on the report, a resource for the user equipment.

52. The apparatus according to claim 51, wherein the at least one memory and the computer program code are further configured to, with storing instructions that, when executed by the at least one processor, cause the apparatus at least to:
receive, from the user equipment, an evaluation threshold in terms of a power headroom value to trigger the uplink duty cycle evaluation.

53. The apparatus according to claim 51, wherein the resource comprises:
a configuration for a user equipment feature, or
a resource grant allocation for data transmission.

54. The apparatus according to claim 51, wherein the at least one memory and the computer program code are further configured to, with storing instructions that, when executed by the at least one processor, cause the apparatus at least to:
determine whether the uplink duty cycle evaluation exceeds a predefined threshold.

55. The apparatus according to claim 54, wherein based on the determination, the at least one memory and the computer program code are further configured to, with storing instructions that, when executed by the at least one processor, cause the apparatus at least to:
start or stop uplink duty cycle monitoring based on the determination.

56. The apparatus according to claim 54, wherein based on the determination, the at least one memory and the computer program code are further configured to, with storing instructions that, when executed by the at least one processor, cause the apparatus at least to:
determine, based on the determination, an uplink duty cycle in a least evaluation period or by taking a threshold in terms of a power headroom value in a relaxed way.
